(19) United States
(12) Patent Application Publication
(10) Pub. No.: US 2013/0268622 A1
(43) Pub. Date: Oct. 10, 2013

(54) INFORMATION PROCESSING APPARATUS AND METHOD FOR INTRODUCING PRODUCT

(71) Applicant: FUJITSU LIMITED, Kawasaki-shi (JP)

(72) Inventor: Kazuo TOMONO, Kawasaki (JP)

(73) Assignee: FUJITSU LIMITED, Kawasaki-shi (JP)

(21) Appl. No.: 13/743,124

(22) Filed: Jan. 16, 2013

(30) Foreign Application Priority Data
Apr. 6, 2012 (JP) 2012-087922

(51) Int. Cl. H04L 29/08

(52) U.S. Cl. CPC H04L 67/02
USPC 709/217

(57) ABSTRACT

An information processing apparatus includes a storage unit, a processor, and a communication unit. The storage unit stores item value information representing item values of respective evaluation items of each product. The item values are results of evaluation regarding the respective evaluation items. The processor creates, when information on a presented product is presented to a user of a terminal device connected to the information processing apparatus via a network, graph information for depicting a graph representing item values of respective evaluation items of the presented product and ranges of item values of respective evaluation items among products in a product group including the presented product, with reference to the item value information stored in the storage unit. The communication unit transmits the graph information created by the processor to the terminal device via the network.

### CROSS-REFERENCE TO RELATED APPLICATION

This application is based upon and claims the benefit of priority of the prior Japanese Patent Application No. 2012-087922, filed on Apr. 6, 2012, the entire contents of which are incorporated herein by reference.

### FIELD

The embodiment discussed herein is related to an information processing apparatus and a method for introducing a product.

### BACKGROUND

Recent development in networks has led to construction of a large number of processing systems for providing services to users of terminal devices that are connected to the systems via networks. A processing system for providing a service is constructed using one or more servers (data processing devices). Processing systems intended to be used by many people or to provide many services are each constructed using a plurality of servers (data processing devices) for the purpose of distributing loads, and thus they generally become very large in scale. Such a processing system is also called a “site”.

There is a product sales service, which is a service provided via a network. A user using a product sales service may purchase a desired product at any place where a terminal device is connectable to a network.

A site (processing system) that provides a product sales service is designed such that information on purchasable products may be presented in order to enable a user to select a desired product. Unfortunately, the actual situation is that, in many cases, a plurality of products exist in the same category as the product that a user is considering purchasing. Makers who manufacture products often develop a plurality of products belonging to the same category and provide them in the form of a series. Under such circumstances, a user often has to select a desired product from among products belonging to the same category. In consideration of this, it would be desirable to provide information that is sufficient to support a user's selection of a desired product.

A user who is considering purchasing a product does not necessarily have sufficient knowledge about the product. Information that represents all products belonging to the same category as the product under consideration for purchase would seem to be useful for such a user. The reason for this is that the provision of information representing all the products together with information on the product under consideration for purchase is expected to allow a user who does not have sufficient knowledge to easily understand the relative positional relationship of the product in the category to which it belongs.

For example, with respect to a personal computer (hereinafter abbreviated as a “PC”), which is a product, PCs are classified by type into a plurality of categories, and their specifications vary in accordance with usage purposes.

For example, a user who wants to enjoy a high quality video on a desktop PC is highly likely to consider purchasing a PC that is higher in image quality than others among desktop PCs. For a user who is considering purchasing such a PC, the relative difference in image quality among desktop PCs may serve as an important factor.

Even a user who places the greatest importance on high image quality often also places great importance on other factors such as the price and processing speed. In view of the above, it would be desirable to provide, from various perspectives, information representing all the products belonging to the same category in order to support a user to purchase a product more appropriately.

Japanese Laid-open Patent Publication No. 2002-109378 and Japanese Laid-open Patent Publication No. 2007-41971 disclose related techniques.

### SUMMARY

According to an aspect of the present invention, provided is an information processing apparatus including a storage unit, a processor, and a communication unit. The storage unit stores item value information representing item values of respective evaluation items of each product. The item values are results of evaluation regarding the respective evaluation items. The processor creates, when information on a presented product is presented to a user of a terminal device connected to the information processing apparatus via a network, graph information for depicting a graph representing item values of respective evaluation items of the presented product and ranges of item values of respective evaluation items among products in a product group including the presented product, with reference to the item value information stored in the storage unit. The communication unit transmits the graph information created by the processor to the terminal device via the network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration of a network system to which an information processing apparatus according to this embodiment is applied;

FIG. 2 depicts an exemplary homepage screen displayed on a terminal device by a server, which is an information processing apparatus according to this embodiment;

FIG. 3 depicts an exemplary page screen of one series of desktop PCs;

FIG. 4 depicts an exemplary item selection screen;

FIG. 5 depicts an exemplary page screen displayed after a combination of items is changed;

FIG. 6 depicts an exemplary page screen displayed by an operation of clicking a “COMPARISON WITH CURRENT PC” button;

FIG. 7 illustrates exemplary contents of a price table;

FIG. 8 illustrates exemplary contents of a specification table;

FIG. 9 illustrates exemplary contents of a size table;

FIG. 10 illustrates exemplary contents of a delivery time table;

FIG. 11 illustrates exemplary contents of a balance table;

FIG. 12 illustrates exemplary contents of an application table;

FIG. 13 illustrates exemplary contents of a service table;

FIG. 14 illustrates exemplary contents of an additional coefficient table;

FIG. 15 is a flowchart of a first page screen creation process;

FIG. 16 is a flowchart of an application usage checking process;

FIG. 17 is a flowchart of a service usage checking process;

FIG. 18 is a flowchart of a usage level checking process;

FIG. 19 is a flowchart of a specification checking process;

FIG. 20A is a flowchart of a point quantification process;

FIG. 20B is a flowchart of a point quantification process;

FIG. 21 is a flowchart of a presented product switching process;

FIG. 22 is a flowchart of a PC comparison displaying process; and

FIG. 23 illustrates exemplary hardware configuration of a computer to which this embodiment is applicable.

### DESCRIPTION OF EMBODIMENT

Hereinafter, an embodiment will be described in detail with reference to the drawings.

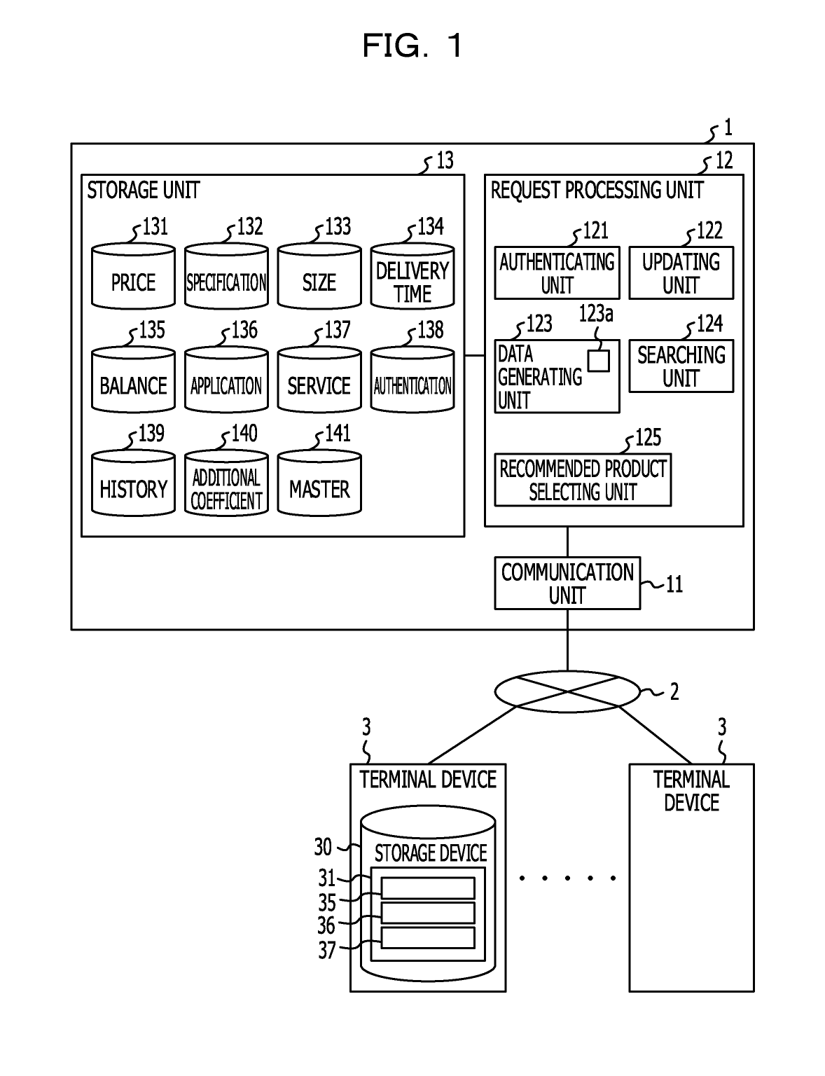

FIG. 1 illustrates an exemplary configuration of a network system to which an information processing apparatus according to this embodiment is applied. As illustrated in FIG. 1, the network system includes a server 1, a network 2, and a plurality of terminal devices 3 connected to the network 2.

The server 1 is a processing system for providing a service targeting users of the terminal devices 3 connected thereto via the network 2. Although a processing system usually has a configuration in which a plurality of servers are connected, it is assumed, here, for convenience of description that the processing system is implemented using one server 1. The information processing apparatus according to this embodiment may be a plurality of information processing apparatuses such as servers.

The server 1 provides a product sales service as a service targeting users of the terminal devices 3 connected thereto via the network 2. In order for a user to make use of the product sales service comfortably, the server 1 provides product data for a product to be sold, if desired. The information processing apparatus according to this embodiment is implemented by the server 1 set up to provide product data to a user. By way of the provision of product data, the server 1 supports suitable and easy selection of a product desired by the user.

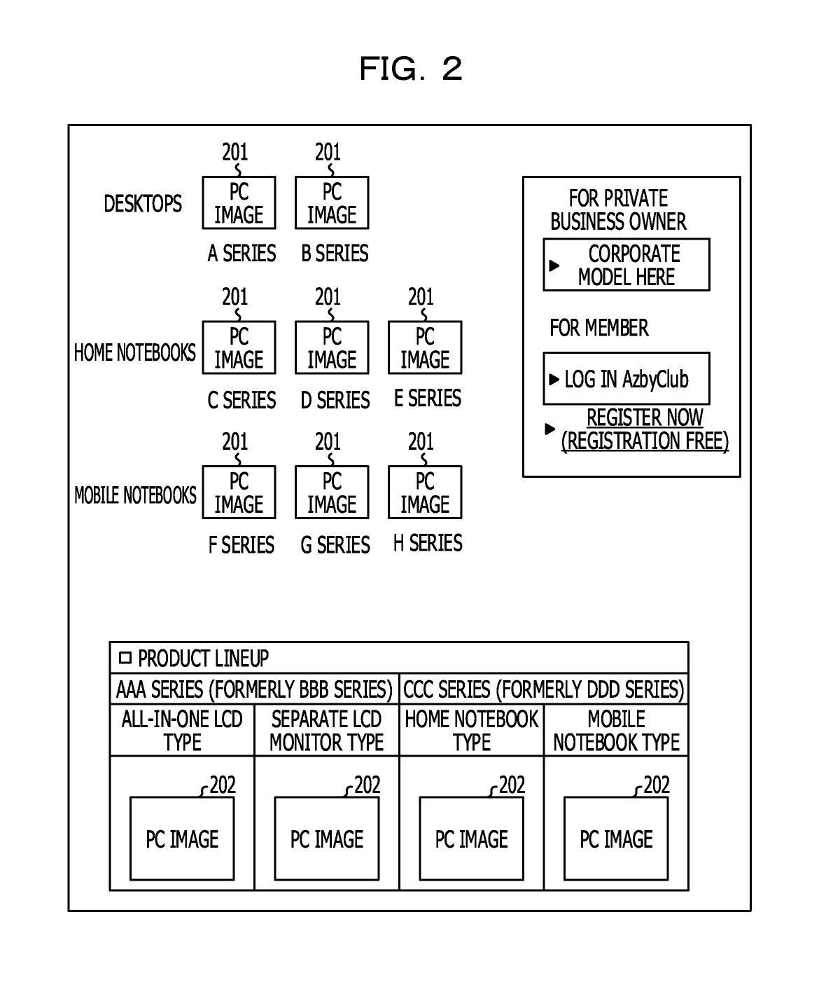

FIG. 2 to FIG. 6 depict exemplary screens displayed on a terminal device 3 by the information processing apparatus according to this embodiment, that is, the server 1. Prior to giving a detailed description of FIG. 1, the provision of product data according to this embodiment, that is, a method for introducing a product will be particularly described with reference to FIG. 2 to FIG. 6. Here, only a PC is assumed as a product for convenience of description.

FIG. 2 depicts an exemplary homepage screen displayed on a terminal device by the server, which is the information processing apparatus according to this embodiment. The server 1 provides a sales service that uses a PC as a product as depicted in FIG. 2. PCs are classified here into three categories: desktops, home notebooks, and mobile notebooks, and each category is further classified into subcategories. In FIG. 2, the subcategory is labeled “series”. There exist two types of desktops, “A series” and “B series”; three types of home notebooks, “C series”, “D series”, and “E series”; and three types of mobile notebooks, “F series”, “G series”, and “H series”. Each series as well as each category is a product group including a plurality of products.

PC images 201 arranged near series names are link buttons for instructing transition to respective page screens of the corresponding series. PC images 202 arranged below the link buttons 201 are also link buttons for instructing transition to respective page screens of desired series. When a mouse cursor is moved over a link button 202, a pop-up menu for selecting any of series belonging to a category corresponding to that link button 202 is displayed. Thus, a user who has caused a homepage screen as depicted in FIG. 2 to be displayed on the terminal device 3 is able to cause a new page screen of the desired series to be displayed on the terminal device 3 by an operation of clicking the link button 201 or link button 202.

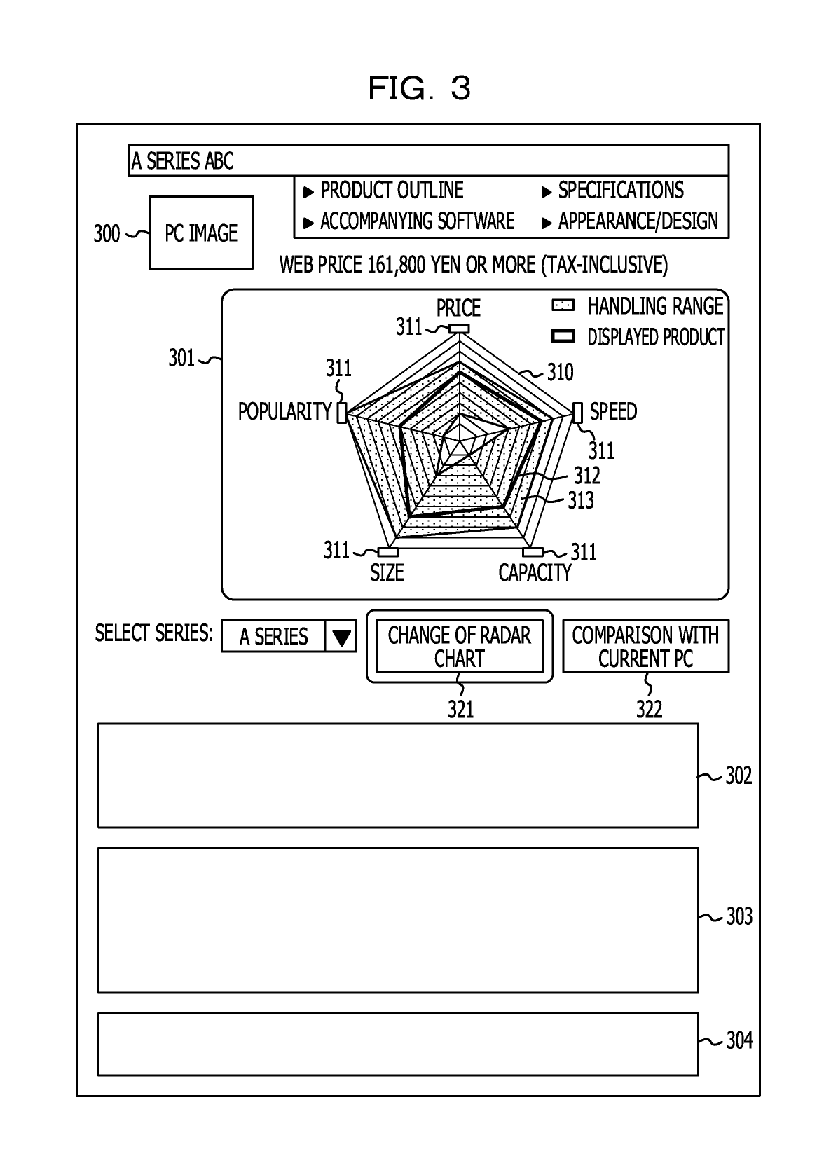

FIG. 3 depicts an exemplary page screen of one series of desktops. A PC image 300 of a product recommended by a seller and a display region 301 for a radar chart 310 are arranged at the top of the page screen of the series of desktops. A display region 302 for an explanation of a recommended product, a display region 303 for an explanation of recommended software, and a display region 304 for an explanation of the warranty services are arranged below the display region 301.

The recommended product is a product selected based on a user's usage history or a product selected by a seller. In this embodiment, when a page screen of any series is first displayed on the terminal device 3, a recommended product is selected and the selected recommended product is presented on the page screen.

The radar chart 310 is arranged within the display region 301. A check box 311 is arranged in the vicinity of each evaluation item (hereinafter, referred to as an item) of the radar chart 310, and a line 312 indicating evaluations regarding respective items of a recommended product is drawn within the radar chart 310. Each item is evaluated on a 10 level scale. A region 313 drawn within the radar chart 310 represents the range of products included in the corresponding series. Accordingly, in FIG. 3, it is indicated that products included in the A series are evaluated as being within the range from 2 to 7 on the 10 level scale in terms of price, and that they are evaluated as being within the range from 1 to 10 on the 10 level scale in terms of popularity. Similarly, it is indicated that the products included in the A series are evaluated as being within the range from 3 to 9 in terms of size, within the range from 1 to 8 in terms of capacity, and within the range from 4 to 8 in terms of speed, on the 10 level scale.

As depicted in FIG. 3, in this embodiment, the evaluation regarding each item of a product being presented and, together therewith, the range of item values for each item of all the products included in the series of that product are indicated by the radar chart 310. This allows a user to easily understand the position of the presented product in the series including the presented product, that is, its relative positional relationship among all the products in terms of each item. Thereby, even if the user has little knowledge of PCs, the user is able to understand relative advantages and disadvantages of the presented product as compared to the other products included in the same series as that product and thereafter examine a product for purchase. As a result, a user may purchase a product that is considered more suitable for the user.

When the user selects a product, the PC image 300 is changed to an image of the product selected by the user, and the line 312 of the radar chart 310 is also changed to a line corresponding to the product selected by the user. Thereby, the user may understand the position of the selected product among all products in the series easily and from various perspectives.

The radar chart 310, in which a plurality of items may be set arbitrarily, allows a product to be examined from various perspectives. Thereby, an understanding of an overview of a product is also easy. For this reason, the radar chart 310 is used for introduction of a product. Graphs other than the radar chart 310 may be adopted if they allow a product to be examined from various perspectives. The user may be allowed to select an arbitrary graph.

The shape of the line 312 varies from one product to another. From this, in this embodiment, the line 312 of the radar chart 310 is to be used for specifying a product that satisfies conditions that the user desires. The check box 311 arranged in the vicinity of each item of the radar chart 310 is provided in order to enable the user to select an item having an item value that is to be changed among items. This makes it possible for the user to change the item value of an item corresponding to the check box 311 in which a checkmark is displayed. Changing the item value itself is possible by performing a dragging operation.

When the user has changed the item value of any item, the server 1 selects a product nearest to the line 312 after the change of the item value, and newly displays an image of the selected product as the PC image 300. Thereby, the user may check the product represented by the line 312. The line 312 indicates the levels achieved for items of a product. By operating the line 312, the user may easily check a product that reaches the level to be achieved for each item.

The nearest product may be selected by using the Euclid distance, for example. In a calculation of the Euclid distance, a weighting coefficient may be used for each item. Other methods may be used. From such a situation, a method for selecting the nearest product is not particularly limited.

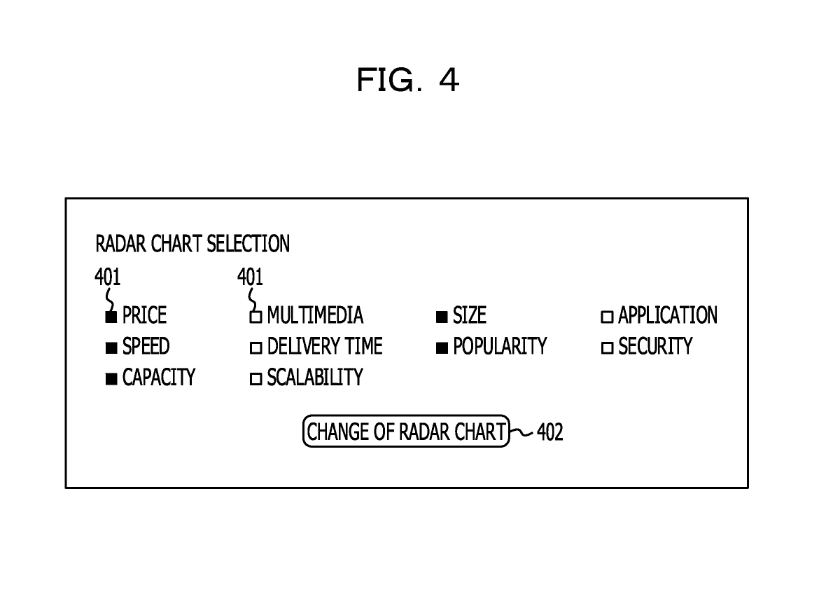

In FIG. 3, “PRICE”, “POPULARITY”, “SIZE”, “CAPACITY”, and “SPEED” are written as item names. However, it is considered that some users may place importance on items other than these items. In consideration of this, a combination of items of the radar chart 310 may be arbitrarily set by the user in this embodiment. A “CHANGE OF RADAR CHART” button 321 depicted in FIG. 3 is a button for creating a combination of items. When the user performs an operation of clicking the button 321, an item selection screen illustrated in FIG. 4 is displayed on the terminal device 3.

In the item selection screen illustrated in FIG. 4, check boxes 401 are arranged for respective item names for items that are selectable as items of the radar chart 310. Accordingly, the user checks the check box 401 of an item that is considered desirable, and removes a checkmark of the check box 401 of an item that is considered unnecessary. Changes of items made in such a manner become effective by an operation of clicking the “CHANGE OF RADAR CHART” button 402.

The operation of clicking the “CHANGE OF RADAR CHART” button 402 causes a return to the previous screen. On the screen after the return caused by the operation of clicking the “CHANGE OF RADAR CHART” button 402, however, the radar chart 310 is displayed with a combination of items selected on the item selection screen. Accordingly, the user may change a combination of items of the radar chart 310 at any time, and check a presented product from another viewpoint.

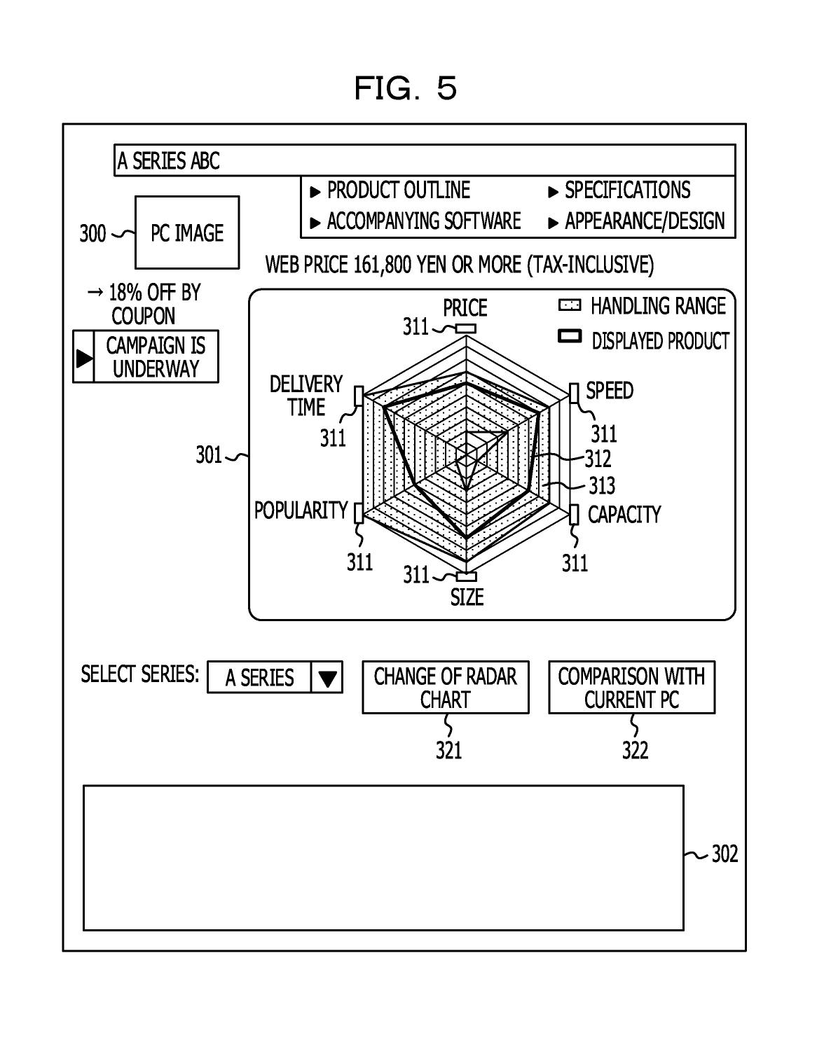

FIG. 5 depicts an exemplary page screen displayed after a combination of items is changed. Here, the case where “DELIVERY TIME” is newly added to the combination of items “PRICE”, “POPULARITY”, “SIZE”, “CAPACITY”, and “SPEED” is assumed. Accordingly, the shape of the radar chart 310 changes from a pentagon to a hexagon. In accordance with the addition of “DELIVERY TIME”, an explanation for the delivery time is added to the display region 302.

There is a possibility that the user has purchased the same type of product in the past at the same site. A “COMPARISON WITH CURRENT PC” button 322 is arranged on the page screens depicted in FIG. 3 and FIG. 5. The “COMPARISON WITH CURRENT PC” button 322 is a button for comparing the presented PC with a PC purchased in the past if the user has previously purchased a PC.

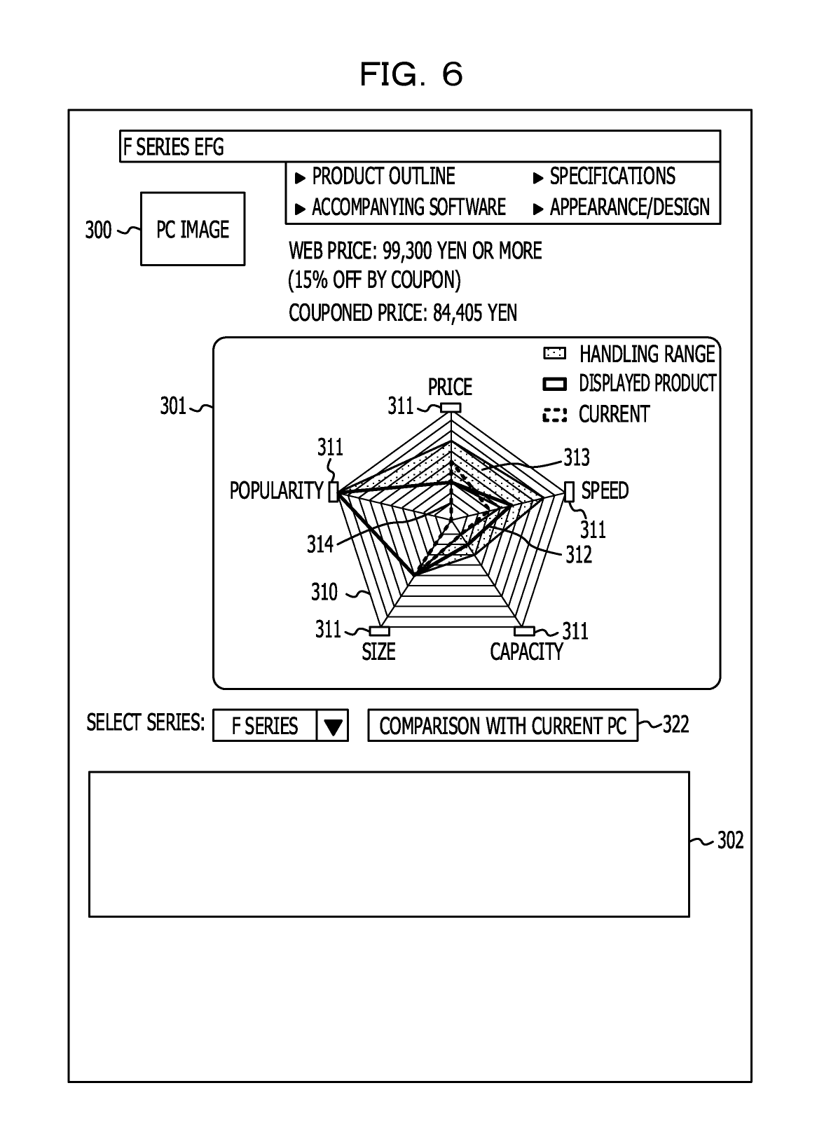

FIG. 6 depicts an exemplary page screen displayed by an operation of clicking the “COMPARISON WITH CURRENT PC” button. As depicted in FIG. 6, the line 312 and the region 313 are drawn, and a line 314 indicating evaluations of a PC purchased in the past by the user is also drawn, in the radar chart 310 on the page screen.

The difference in value of each item between the line 314 and the line 312 indicates the difference in evaluation regarding the corresponding item between the PC purchased in the past and the currently presented PC. An increase in performance of a central processing unit (CPU) mounted in PCs is significant, and the capacity of storage exemplified by hard disk drives (HDDs) is also increasing. For this reason, the PC purchased in the past is evaluated as being low with regard to the items of speed and capacity. The differences in evaluation regarding the items of speed and capacity may be useful information for examining the necessity of purchasing a PC.

In this embodiment, the server 1 achieves display of screens as mentioned above on the terminal device 3, as processing concerning purchase of a product. For that purpose, the server 1 includes a communication unit 11, a request processing unit 12, and a storage unit 13 as depicted in FIG. 1.

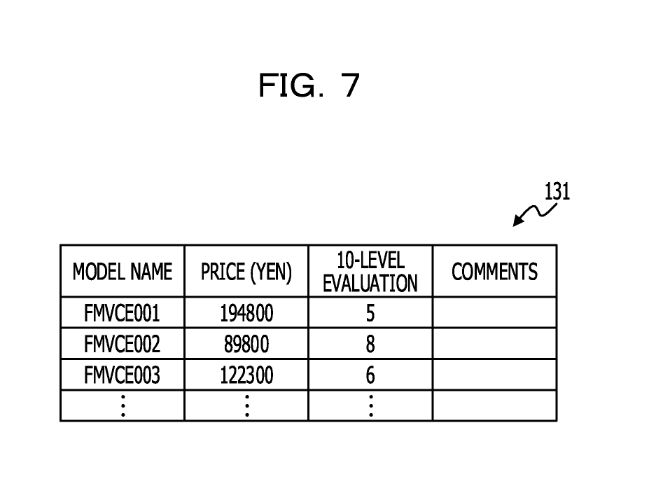

The communication unit 11 achieves communication with the terminal device 3 via the network 2. The request processing unit 12 performs processing for responding to a request from the terminal device 3. Data that is used for the request processing unit 12 to perform various kinds of processing is stored in the storage unit 13. More particularly, a price table 131, a specification table 132, a size table 133, a delivery time table 134, a balance table 135, an application table 136, a service table 137, an authentication database (hereinafter abbreviated as “DB”) 138, a history DB 139, an additional coefficient table 140, and a master DB group 141 are stored in the storage unit 13. In FIG. 1, product data, such as an image of a product and detailed data of specifications, is omitted. First, with reference to FIG. 7 to FIG. 14, the price table 131, the specification table 132, the size table 133, the delivery time table 134, the balance table 135, and the application table 136, the service table 137, and the additional coefficient table 140 will be described in detail.

FIG. 7 illustrates exemplary contents of a price table. As listed in FIG. 7, data of the model name, the price (yen), the 10-level evaluation, and comments is stored in the price table 131 for every PC, which is a product. The model name is identification data that uniquely identifies a PC. The price represents the price of a PC. The 10-level evaluation represents the price evaluated on a 10 level scale. The larger the value is, the smaller the price is. The price table 131 is used for determining the item value of price, which is a selectable item of the radar chart 310.

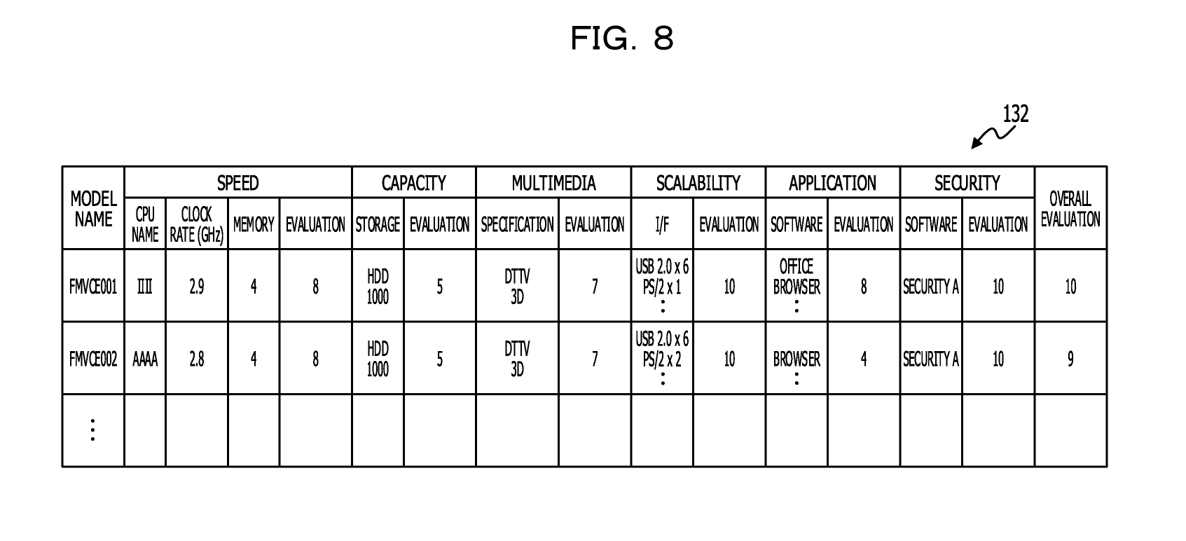

FIG. 8 illustrates exemplary contents of a specification table. The specification table 132 is used for determining item values for items of speed, capacity, multimedia, scalability, application, and security among selectable items of the radar chart 310. As listed in FIG. 8, data of the model name, speed-related items, capacity-related items, multimedia-related items, scalability-related items, application-related items, security-related items, and 10-level evaluation for every PC is stored in the specification table 132.

The model name is identification data of a PC. The data of speed-related items includes data of the CPU name which uniquely identifies a CPU, clock rate (GHz), memory (GB), and 10-level evaluation. Accordingly, the evaluation regarding speed, which is an item of the radar chart 310, is made in consideration of the clock rate and the memory capacity in addition to the type of a CPU. The faster the processing is performed, the higher the value of 10-level evaluation is. The value of 10-level evaluation is handled as an item value regarding speed.

The data of capacity-related items is data concerning storage, such as an HDD mounted in a PC, and includes data of the storage and 10-level evaluation. The storage data represents the type and capacity of storage. The 10-level evaluation is made on the basis of the capacity of storage, and the more the capacity increases, the more the value of the 10-level evaluation increases. The value of 10-level evaluation is handled as an item value regarding capacity.

The data of multimedia-related items includes data of multimedia-related specifications and 10-level evaluation. The specification data is data representing equipment associated with a video output or acoustic output. With respect to “DTTV” and “3D” denoted in FIG. 8, the former means that digital terrestrial television broadcasting is available, and the latter means that a PC is equipped with a three-dimensional display. The higher the functionality of equipment is and the larger the number of pieces of equipment is, the higher the value of the 10-level evaluation is. The value of 10-level evaluation is handled as an item value regarding multimedia.

The data of scalability-related items includes data of the interface (I/F) and 10-level evaluation. The interface data represents the types of interfaces mounted in a PC and the number of interfaces of each type, or the types of empty slots and the number of empty slots of each type, and so on. The larger the number of interfaces or empty slots is, the higher the value of the 10-level evaluation is in accordance with the type of interfaces or empty slots. The value of 10-level evaluation is handled as an item value regarding scalability.

The data of application-related items includes data of the software and 10-level evaluation. The software data represents application software installed in a PC or installable application software. The larger the number of application software is and the higher the price of the application software is, the higher the value of the 10-level evaluation is. The value of 10-level evaluation is handled as an item value regarding application.

The data of security-related items includes data of software and 10-level evaluation. The software data represents software installed for security. The 10-level evaluation represents a security level realizable by the installed security software. The value of 10-level evaluation is handled as an item value regarding security.

The overall evaluation, which is stored as data separate from the data of speed-related items, capacity-related items, multimedia-related items, scalability-related items, application-related items, and security-related items, represents the evaluation regarding the entire specifications of a PC. The higher the specifications are, the higher the value of an overall evaluation is.

The series and category to which each PC is included is managed by using a table that is not illustrated in FIG. 1. The table is denoted as a “PC management table” hereinafter.

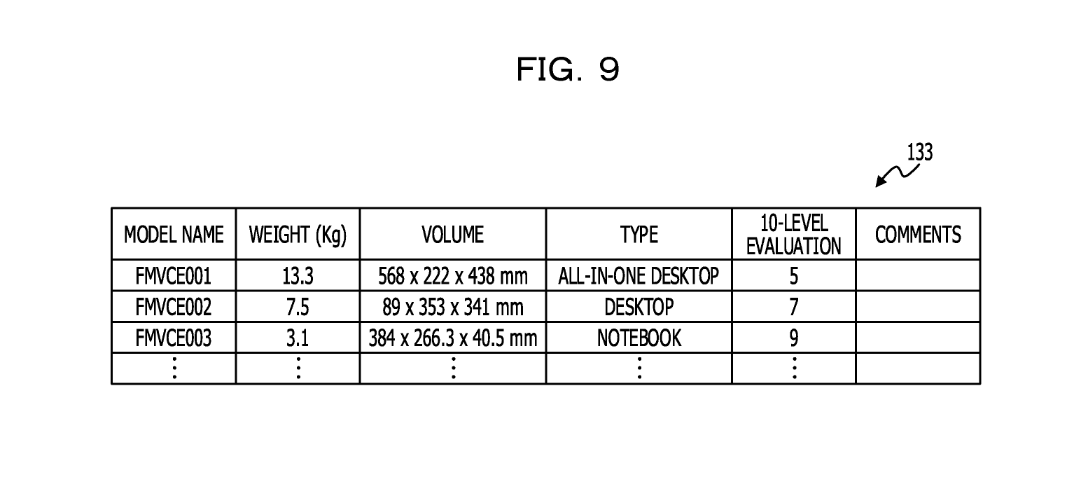

FIG. 9 illustrates exemplary contents of a size table. As listed in FIG. 9, data of the model name, weight (kg), volume, type, 10-level evaluation, and comments for every PC is stored in the size table 133. The lighter the weight is and the smaller the volume is, the higher the value of the 10-level evaluation is. The value of 10-level evaluation is handled as an item value regarding size.

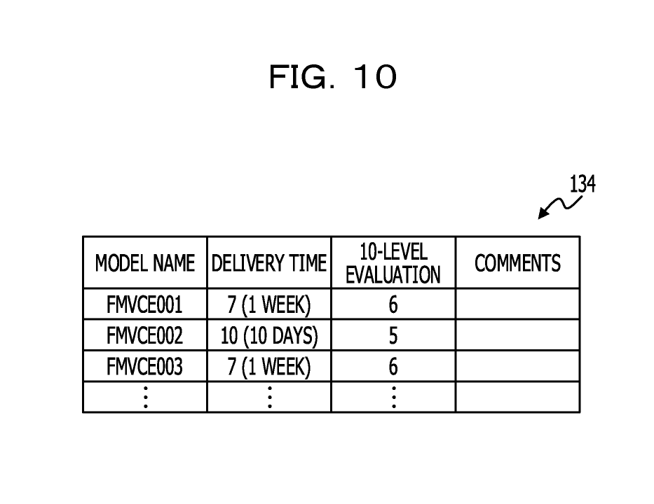

FIG. 10 illustrates exemplary contents of a delivery time table. As listed in FIG. 10, data of the model name, delivery time, 10-level evaluation, and comments for every PC is stored in the delivery time table 134. The shorter the delivery time is, the higher the value of the 10-level evaluation is. The value of 10-level evaluation is handled as an item value regarding delivery time.

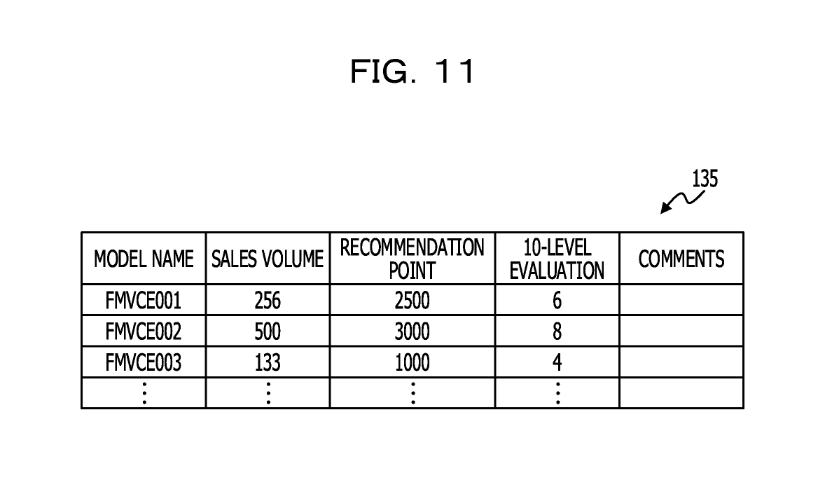

FIG. 11 illustrates exemplary contents of a balance table. As listed in FIG. 11, data of the model name, sales volume, recommendation point, 10-level evaluation, and comments for every PC is stored in the balance table 135. The recommendation point represents the degree of recommendation of the PC by a seller, for example. The larger the sales volume is and the higher the value of the recommendation point is, the higher the value of the 10-level evaluation is. The value of 10-level evaluation is handled as an item value regarding popularity.

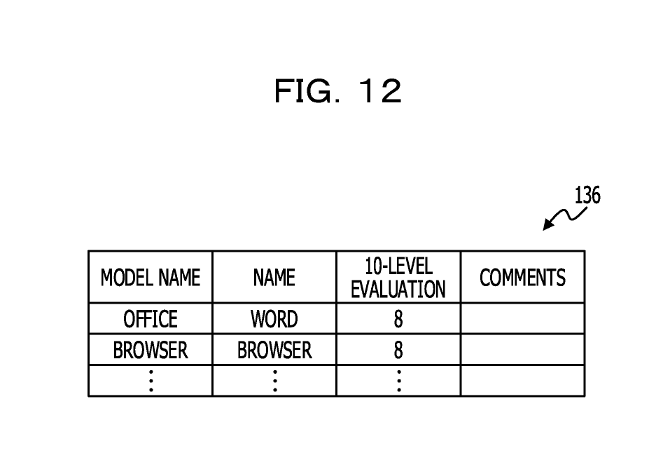

FIG. 12 illustrates exemplary contents of an application table. As listed in FIG. 12, data of the model name, name, 10-level evaluation, and comments for every piece of application software is stored in the application table 136. The model name used here is identification data of application software.

The load for operating application software varies depending on the application software. The heavier the load of application software is, the higher the specifications expected to a PC is. The application table 136 is a table for determining specifications expected to a PC to be purchased, on the basis of the application software used by the user. Thereby, the heavier the load is and the larger the resources to be used are, the higher the value of the 10-level evaluation is.

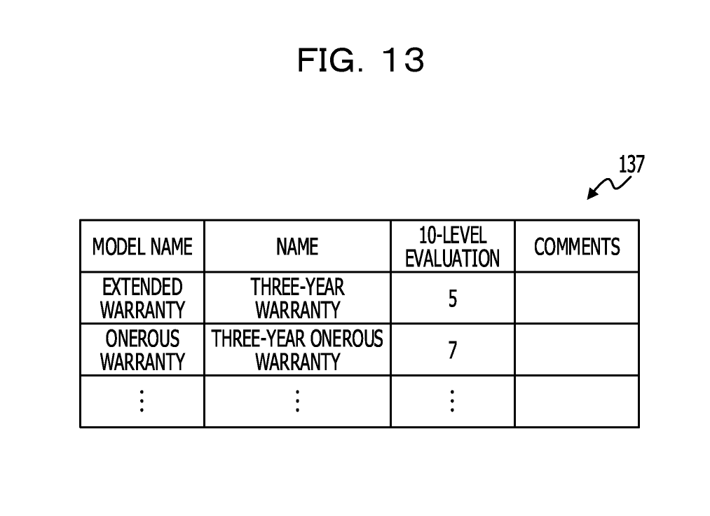

FIG. 13 illustrates exemplary contents of a service table. As listed in FIG. 13, data of the model name, name, 10-level evaluation, and comments for every warranty service for a purchaser of a PC is stored in the service table 137. The model name used here is identification data of a warranty service. The richer the warranty services are, the higher the value of the 10-level evaluation is.

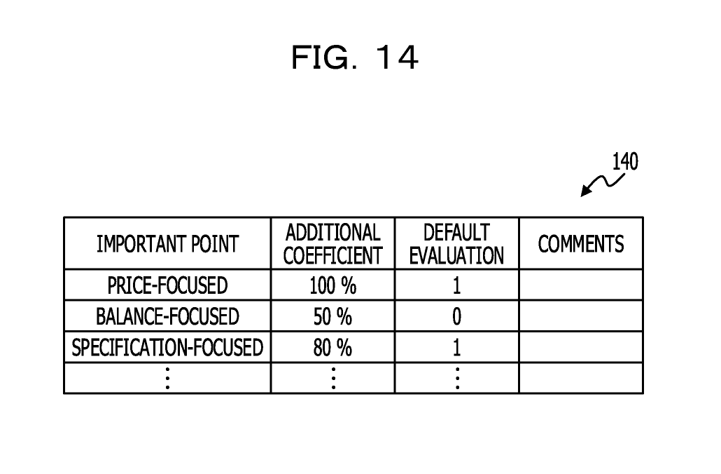

FIG. 14 illustrates exemplary contents of an additional coefficient table. As listed in FIG. 14, data of the important point, additional coefficient, default evaluation, and comments for every item that is settable in the radar chart 310 is stored in the additional coefficient table 140. The important point is data representing an item.

In this embodiment as described above, the recommended product is a product selected based on a user's usage history or a product selected by a seller. The additional coefficient table is used for selecting a recommended product among products in the series selected by the user when selection of the recommended product based on the user's usage history is not available. In this embodiment, the item value of each item of a PC with the best specifications in the series is multiplied by the additional coefficient of each item stored in the additional coefficient table.

The result of multiplication of each item is used for selection of items to be set in the radar chart 310. Accordingly, for example, a predetermined number of items are extracted in descending order of multiplication results, and the extracted items are set as items of the radar chart 310. The default evaluation is used when such setting of items is not available. In such a case, items having “1” as the default evaluation are set.

In this embodiment, the user is allowed to perform member registration. The authentication DB 138 is a database for authenticating members, and an identifier (ID), a password, and personal data are stored therein for every member.

The history DB 139 is a DB in which, for every user who has obtained a service, the contents and the like of the service are saved as the user's usage history. The type of a PC purchased in the past by the user, the time of purchase, the contents of responses to questionnaires, and the like may be identified by referring to the history DB 139.

The 10-level evaluations stored as data in the various tables depicted in FIG. 7 to FIG. 12 are extracted from the corresponding master DBs. The master DB group 141 is an aggregate of such master DBs. Each master DB, which constitutes the master DB group 141, is updated as occasions arise, such as the start of sales of new application software and the debut of a PC equipped with a new CPU. Therefore, even regarding a PC that is not registered in the specification table 132 and the like, it is possible to determine the item value of each item if the detailed data of the PC is found.

The request processing unit 12, which performs processing with reference to data as mentioned above, includes an authenticating unit 121, an updating unit 122, a data generating unit 123, a searching unit 124, and a recommended product selecting unit 125.

The authenticating unit 121 authenticates the identity of a user who has performed member registration, thereby enabling login or logout of the user. The updating unit 122 updates the various tables and various DBs stored in the storage unit 13 if desired.

The data generating unit 123 generates data, which is desired by a user's request. The radar chart 310 arranged on a page screen varies from one user to another. For this reason, the data generating unit 123 includes a graph generating unit 123a that generates a graph containing the radar chart 310.

The searching unit 124 performs data search from among various DBs 138 and 139, or the master DB group 141. The recommended product selecting unit 125 selects a product to be arranged as the PC image 300 on the page screen depicted in FIG. 3.

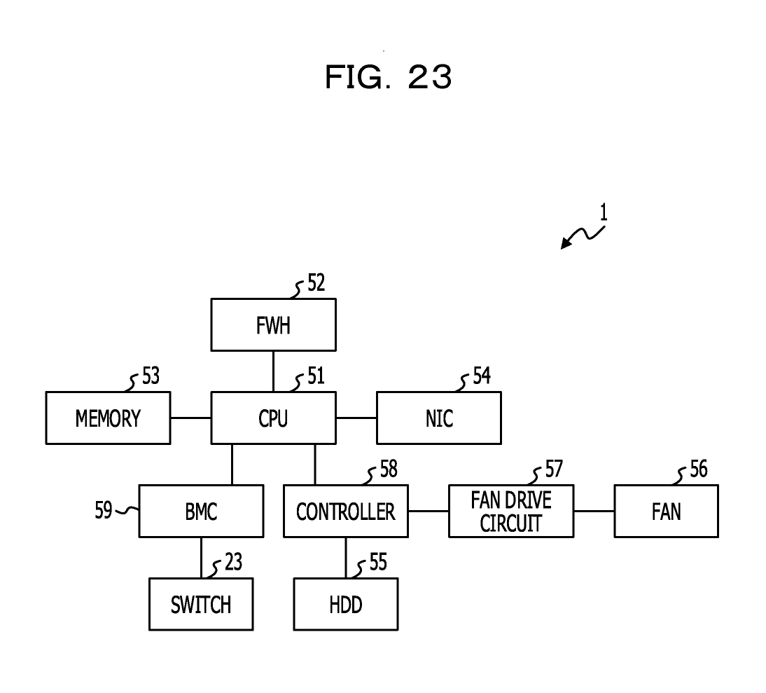

The server 1 including the request processing unit 12 as mentioned above may be implemented by causing a computer to execute a program that enables display of page screens as depicted in FIG. 2 to FIG. 6, for example. Here, with reference to FIG. 23, an exemplary hardware configuration of a computer to which this embodiment is applicable will be described in detail. The program that enables display of page screens as depicted in FIG. 2 to FIG. 6 is referred to hereinafter as a “Web application”.

A computer to which this embodiment is applicable includes, a CPU 51, a firmware hub (FWH) 52, a memory (memory module) 53, a network interface card (NIC) 54, an HDD 55, a fan 56, a fan drive circuit 57, a controller 58, and a baseboard management controller (BMC) 59 as depicted in FIG. 23, for example. Such a configuration is exemplary and is not limited as a configuration of a computer that is usable as the server 1.

The FWH 52 is a memory in which a basic input/output system (BIOS) is stored. The BIOS is read into the memory 53 and is executed by the CPU 51. An operating system (OS) and various pieces of application software including the aforementioned Web application are stored in the HDD 55. This allows the CPU 51 to read the OS from the HDD 55 via the controller 58 and execute the OS after completion of start-up of the BIOS. The start-up of the BIOS enables communication to be made via the NIC 54.

The BMC 59 is a device for managing a computer. The BMC 59, which has a communication function, is capable of communicating with an external device via a switch 23. The BMC 59 is capable of controlling start or stop of the computer, that is, on or off of the power supply, in accordance with an instruction from the external device.

In the configuration depicted in FIG. 23, the storage unit 13 of FIG. 1 corresponds to the HDD 55, for example. The communication unit 11 corresponds to the NIC 54, for example. In cases where the OS and the aforementioned Web application are stored in the HDD 55, the request processing unit 12 is implemented by the CPU 51, FWH 52, memory 53, controller 58, and HDD 55. The Web application may be stored in a storage device other than the HDD 55. The Web application may also be stored in a portable recording medium and be acquired from an external device over a network or the like.

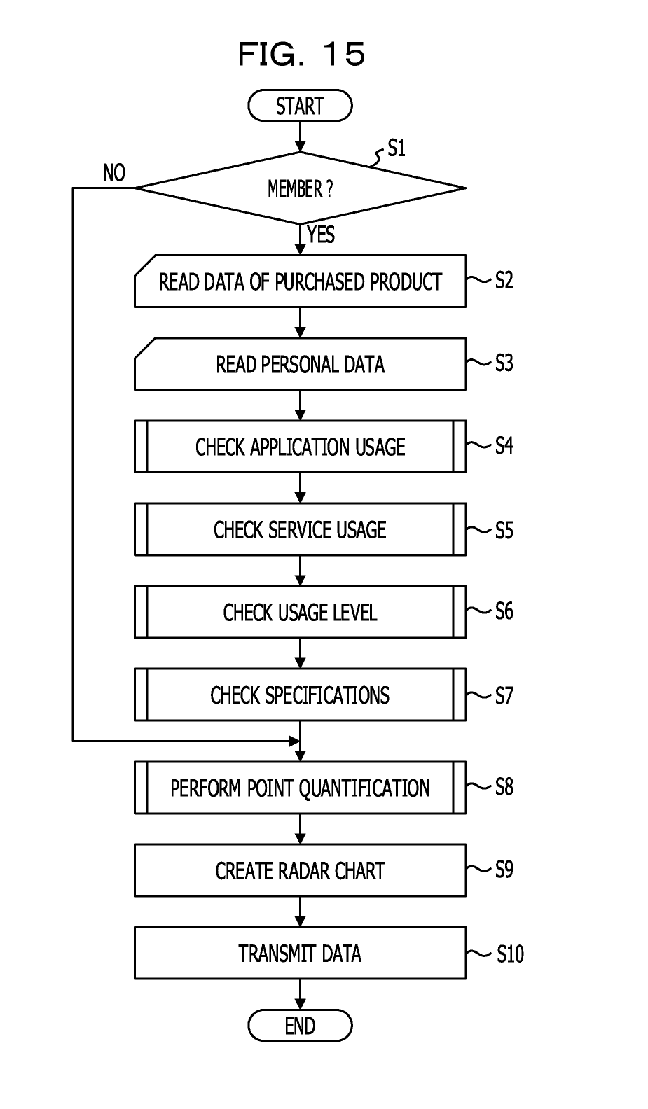

Hereinafter, processing implemented by the CPU 51 executing the Web application will be described in detail with reference to each flowchart depicted in FIG. 15 to FIG. 22.

FIG. 15 is a flowchart of a first page screen creation process. The first page screen creation process is a process that is performed in order to display a page screen as depicted in FIG. 3 on the terminal device 3 when the user operates either of the buttons 201 and 202 in FIG. 2 to select a series. With reference to FIG. 15, the first page screen creation process will be described in detail.

The CPU 51 determines whether the user of the terminal device 3 is a member (S1). When the user has not logged in, the determination result in S1 is No and the process proceeds to S8. When the user has logged in, the determination result in S1 is Yes and the process proceeds to S2.

Proceeding to S2 means that there is a possibility of selecting a recommended product on the basis of the user's usage history. From this, in S2 to S8, processing for generating data used for selecting a recommended product on the basis of the user's usage history is performed.

In S2, referring to the history DB 139 by using the user's ID, for example, the CPU 51 extracts data of a product purchased in the past by the user from the history DB 139. Then, the CPU 51 reads personal data 31 from the terminal device 3 (S3). Thereafter, the process proceeds to S4.

In this embodiment, a user who wants to perform member registration is asked to accept collection of the personal data 31 saved in the storage device 30 of the terminal device 3 being used. Specifically, the personal data 31 includes resource data 35 regarding resources (specifications) of the terminal device 3, application data 36 regarding installed application software, and service usage data 37 regarding services used in the past. Such the personal data 31 is collected by performing the processing of S3.

In S4, the CPU 51 performs an application usage checking process. The application usage checking process is performed in order to evaluate specifications desired for the recommended product by using the application data 36 included in the personal data 31.

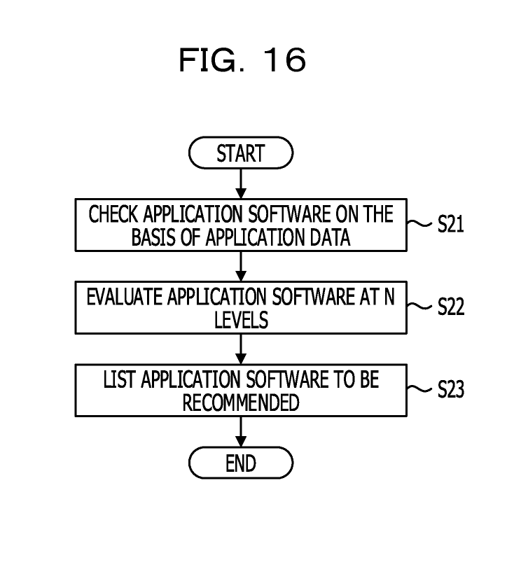

FIG. 16 is a flowchart of an application usage checking process.

In the application usage checking process, the CPU 51 checks, on the basis of the application data 36, application software used by the user (S21). Then, referring to the application table 136 depicted in FIG. 12, the CPU 51 determines the value of 10-level evaluation corresponding to the checked application software (S22). Here, “N” in FIG. 16 represents “10”. Then, the CPU 51 lists application software to be recommended from the checked application software (S23). Thereafter, the application usage checking process is completed. The application software to be recommended is, for example, a new version of application software currently used by the user, other application software developed on the assumption of the currently used application, and the like.

After performing the application usage checking process as depicted in FIG. 16 in S4, the CPU 51 performs a service usage checking process (S5). The service usage checking process is a process for checking a warranty service used by the user and listing a service to be recommended to the user.

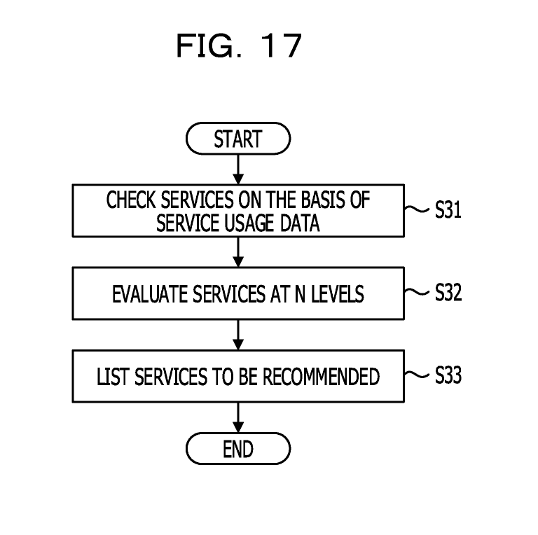

FIG. 17 is a flowchart of a service usage checking process.

In the service usage checking process, the CPU 51 checks, on the basis of the service usage data 37, warranty services used by the user (S31). Then, referring to the service table 137 depicted in FIG. 13, the CPU 51 determines the values of 10-level evaluations corresponding to the checked services (S32). Here, “N” in FIG. 17 represents “10”. Then, the CPU 51 lists services to be recommended, in the case of purchasing the recommended product, on the basis of the checked services and the values of 10-level evaluations (S33). Thereafter, the service usage checking process is completed. The services to be recommended are, for example, services currently used by the user, other services equivalent to the currently used services in terms of warranty, services recommended by a seller, or the like.

After performing the service usage checking process as depicted in FIG. 17 in S5, the CPU 51 performs a usage level checking process (S6). The usage level checking process is a process for evaluating specifications that are to be satisfied by a product recommended to the user, on the basis of the result of a questionnaire to which the user has responded in the past. When the user has responded to a questionnaire in the past, questionnaire data representing the questionnaire result is saved in the history DB 139.

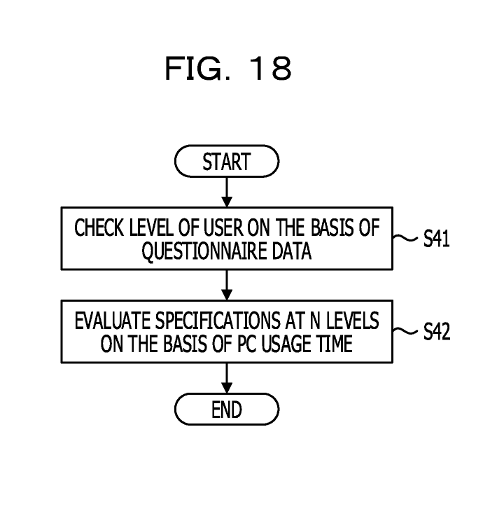

FIG. 18 is a flowchart of a usage level checking process.

In the usage level checking process, the CPU 51 checks the level of PC skills of the user on the basis of the questionnaire data (S41). The questionnaire contains questions that are considered to be effective for estimating the skills of a user, the purpose of usage of a PC, and the like. As a result, the answers to questions allow the user's level to be estimated.

Then, the CPU 51 causes the answer to a question as to PC usage time provided in the questionnaire to be reflected in the estimated level, and evaluates specifications that are to be satisfied by a recommended product on a 10 level scale on the basis of the reflection result (S42). Here, “N” in FIG. 18 represents “10”. Thereafter, the usage level checking process is completed. The reason why the estimated level is changed on the basis of usage time is that a person who only browses pages using the Internet is considered to be not so high in terms of the level of skills even if the person uses a PC heavily.

After performing the usage level checking process as depicted in FIG. 18 in S6, the CPU 51 performs a specification checking process (S7). The specification checking process is a process for evaluating specifications that are to be satisfied by a product recommended to the user, on the basis of a PC that the user has purchased in the past. When the user has purchased a PC in the past, the specification data representing the PC purchased by the user is saved in the history DB 139. The specification data is such data as to be stored in one record (entry) of the specification table 132 depicted in FIG. 8.

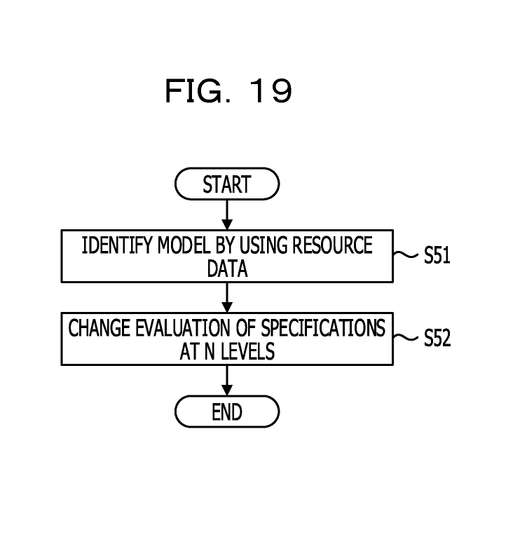

FIG. 19 is a flowchart of a specification checking process.

In the specification checking process, the CPU 51 refers to the specification table 132 by using the resource data 35 in the collected personal data 31, identifies model name corresponding to the resource data 35, and extracts the value of 10-level evaluation regarding the specifications (S51). Then, the CPU 51 changes the extracted 10-level evaluation in consideration of the evaluation results obtained from results of performing the application usage checking process of FIG. 16 and the usage level checking process of FIG. 18 (S52). Here, “N” in FIG. 19 represents “10”. Thereafter, the specification checking process is completed.

In many cases, the reason why a user considers purchasing a new PC is that the specifications of a PC being used are too low, unless there is a reason such as a breakdown of a PC being used or a new demand for a PC. This means that the specifications of a PC that has been purchased in the past are not so helpful for selecting a recommended product. It is for this reason that the extracted 10-level evaluation is changed if desired. Performing the specification checking process results in definite determination of the value of 10-level evaluation regarding specifications that are to be satisfied by a recommended product.

After performing the specification checking process as depicted in FIG. 19 in S7, the CPU 51 performs a point quantification process (S8).

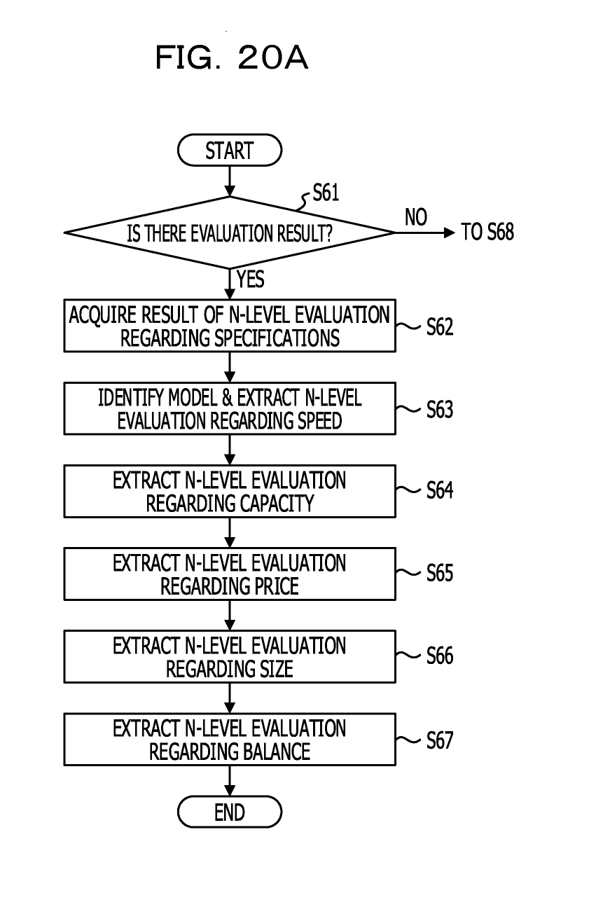

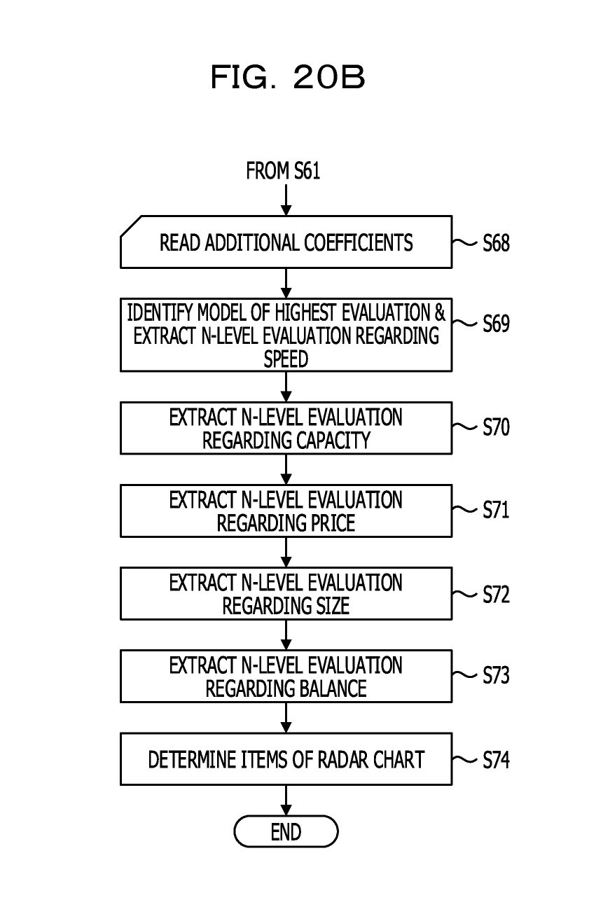

The point quantification process is a process for determining a recommended product and determining the item value of each item of the radar chart 310. With reference to FIG. 20A and FIG. 20B, the point quantification process will be described in detail. Here, “N” in FIG. 20A and FIG. 20B represents “10”.

The CPU 51 determines whether there is a result of 10-level evaluation (S61). As mentioned above, when the user is not a member, then 10-level evaluation regarding specifications that are to be satisfied by a recommended product is not performed. From this, when the user is not a member, then the determination result in S61 is No and the process proceeds to S68 of FIG. 20B. When the user is a member, then the determination result in S61 is Yes and the process proceeds to S62.

There may be a case where a user who is a member has not responded to a questionnaire in the past. With the user who has not responded to a questionnaire in the past, the value of 10-level evaluation regarding specifications is not acquired by performing the usage level checking process as depicted in FIG. 18. In addition, the terminal device 3 used by the user is not necessarily a PC. For this reason, the value of 10-level evaluation is not necessarily determined at the time of S52. Therefore, in S61, even in the case where the user is a member, the determination result is No when the value of 10-level evaluation has not been determined.

In S62, the CPU 51 acquires a result of 10-level evaluation regarding specifications that are to be satisfied by a recommended product. Then, referring to the specification table 132 depicted in FIG. 8, the CPU 51 selects an entry in which the same result as the result of 10-level evaluation or a result that is closest to the result of 10-level evaluation is stored, and extracts the model name data of the selected entry. The CPU 51 also extracts the value of 10-level evaluation among the data of speed-related items stored in the selected entry (S63). Subsequently, the CPU 51 extracts the value of 10-level evaluation among the data of capacity-related items stored in the selected entry (S64). From then on, referring to the price table 131 depicted in FIG. 7, the size table 133 depicted in FIG. 9, and the balance table 135 depicted in FIG. 11, the CPU 51 extracts their respective values of 10-level evaluations by using the extracted model name data (S65 to S67). Thereafter, the point quantification process is completed.

In such a way, in this embodiment, in the case where a user is a member, a recommended product is selected by using the value of 10-level evaluation regarding specifications, and the values of 10-level evaluations serving as the item values of the predetermined items of the selected recommended product are extracted. The extracted values of 10-level evaluations for items are important point values.

In S68, to which the process proceeds when the determination result in S61 is No, and later, processing for determining a recommended product and item values of items in accordance with the predetermined rules is performed.

In S68 of FIG. 20B, the CPU 51 reads each additional coefficient from the additional coefficient table 140 depicted in FIG. 14. Then, referring to the specification table 132 depicted in FIG. 8, the CPU 51 selects an entry in which the highest value of 10-level evaluation regarding specifications in the series selected by the user is stored, and extracts the model name data and the value of 10-level evaluation among the data of speed-related items from the selected entry (S69). Subsequently, the CPU 51 extracts the value of 10-level evaluation among the data of capacity-related items stored in the selected entry (S70).

From then on, referring to the price table 131 depicted in FIG. 7, the size table 133 depicted in FIG. 9, and the balance table 135 depicted in FIG. 11, the CPU 51 extracts their respective values of 10-level evaluations by using the extracted model name data (S71 to S73).

After completion of extraction, the CPU 51 calculates the item value of each item by multiplying the extracted value of 10-level evaluation by the corresponding additional coefficient read in S68. Then, a product whose item values are closest to the calculated item values is selected as a recommended product, and items of the radar chart 310 are determined (S74). Thereafter, the point quantification process is completed.

By performing the above point quantification process, a recommended product is determined and the item values of items set in the radar chart 310 of the recommended product are determined. Upon completion of the point quantification process, the process proceeds to S9.

In S9, the CPU 51 performs a radar chart creation process. The item value of each item obtained by performing the point quantification process is used as the item value of each item of a recommended product, and the range of the item value of each item of all products in the same series is determined by checking the item value of each item of each product. Therefore, the radar chart 310 as depicted in FIG. 3 is created by performing the radar chart creation process. Part of the graph generating unit 123a in the data generating unit 123 of FIG. 1 is implemented by the CPU 51 performing the radar chart creation process.

In S10 subsequent to S9, the CPU 51 creates a page screen in which the created radar chart 310 and the PC image 300 of the recommended product are arranged, and transmits the page screen to the terminal device 3. Thereafter, the first page screen creation process is completed.

The transmission of the above page screen causes a page screen as depicted in FIG. 3 to be displayed on the terminal device 3. Thereafter, in the case where a combination of items is changed, the radar chart creation process as in S9 mentioned above is performed again, resulting in a change in the radar chart 310 to be displayed. Thereby, the terminal device 3 will display a new page screen as depicted in FIG. 5.

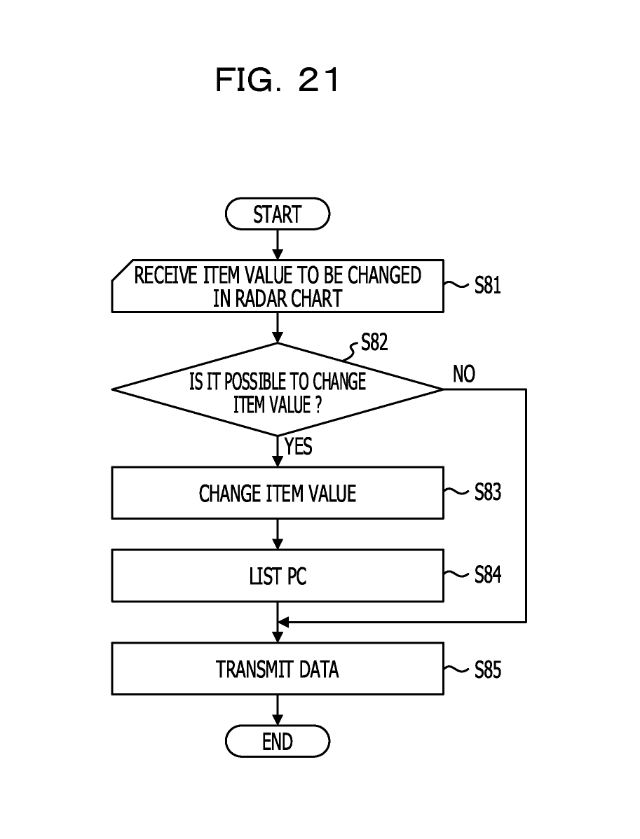

FIG. 21 is a flowchart of a presented product switching process. When the user changes the item value of any item of the radar chart 310, the presented product switching process is performed for selecting a product designated by using the item values of items after the change, that is, a product whose item values of the items are closest to those after the change. With reference to FIG. 21, the presented product switching process will be described in detail.

The CPU 51 receives data concerning change in item value of the line 312 of the radar chart 310 from the terminal device 3 (S81). Then, the CPU 51 determines whether it is possible to change an item value of an item represented by the received data (S82). When the user of the terminal device 3 tries to change an item value of an item whose check box 311 is not checked, the determination of S82 is No and the process proceeds to S85. When the user of the terminal device 3 tries to change an item value of an item whose check box 311 is checked, the determination of S82 is Yes and the process proceeds to S83.

In S83, the CPU 51 changes an item value in accordance with an operation of the user of the terminal device 3. Then, the CPU 51 lists a product whose item values are closest to the item values for items including the changed item value (S84). The product is listed with reference to the various tables 131 to 135 depicted in FIG. 7 to FIG. 11 if desired.

In S85 subsequent to S84, the CPU 51 transmits data for notification of a result. When a listed product exists, a page screen in which an image of the listed product is newly arranged as the PC image 300 is transmitted to the terminal device 3. When the listed product does not exist, or when the change of an item value is invalid, data that enables a user to recognize such a situation is transmitted. After the transmission of data, the presented product switching process is completed.

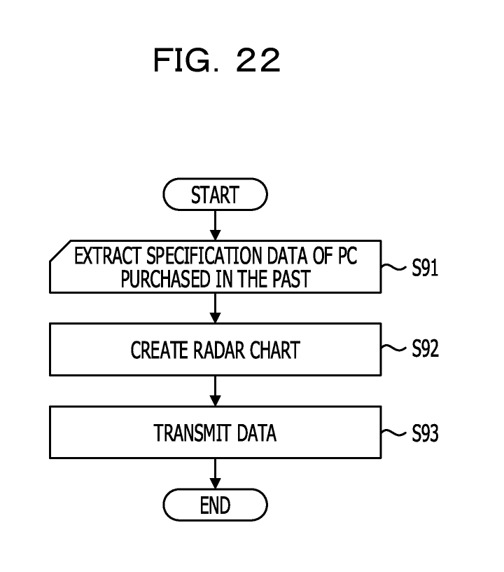

FIG. 22 is a flowchart of a PC comparison displaying process. As described above, in this embodiment, when the user performs an operation of clicking the “COMPARISON WITH CURRENT PC” button, the line 314 indicating a PC purchased in the past by the user will be displayed on the radar chart 310. The PC comparison displaying process is a process for addressing a user's operation of clicking the “COMPARISON WITH CURRENT PC” button 322. With reference to FIG. 22, the PC comparison displaying process will be described in detail.

Referring to the history DB 139, the CPU 51 extracts the specification data of a PC purchased in the past by the user who has performed the operation of clicking the “COMPARISON WITH CURRENT PC” button 322 (S91). Then, the CPU 51 performs the radar chart creation process for newly drawing the line 314 on the current radar chart 310 using the extracted result of the specification data (S92). Thereafter, the CPU 51 performs data transmission for displaying the created radar chart 310 (S93). The PC comparison displaying process is completed thereafter.

When the user has not purchased a PC in the past, it is impossible to draw the line 314. For this reason, when the user who has not purchased a PC in the past performs an operation of clicking the “COMPARISON WITH CURRENT PC” button 322, data transmission for notification of such a situation is performed in S93.

Note that, although attention is paid to a PC as a product in this embodiment, the product may be goods other than a PC. Also, although this embodiment is implemented by the server 1, which is a processing system for providing a product sales service, this embodiment may be included in a processing system that does not provide a product sales service. That is, this embodiment may be applied to a processing system or a server (information processing apparatus) that provides a service for the purpose of supporting a user to examine a desired product. Also, in this embodiment, although products for determining the region 313 are all the products included in the same series, they may be a plurality of products selected from among all the products.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a storage unit to store item value information representing item values of respective evaluation items of each product, the item values being results of evaluation regarding the respective evaluation items;
a processor to create, when information on a presented product is presented to a user of a terminal device connected to the information processing apparatus via a network, graph information for depicting a graph representing item values of respective evaluation items of the presented product and ranges of item values of respective evaluation items among products in a product group including the presented product, with reference to the item value information stored in the storage unit; and
a communication unit to transmit the graph information created by the processor to the terminal device via the network.

2. The information processing apparatus according to claim 1, wherein
when an item value of an evaluation item of the presented product has been changed, the presented product is switched to another product on the basis of the changed item value.

3. The information processing apparatus according to claim 1, wherein
when the user designates the product group, the presented product is selected from among products included in the designated product group by a seller or based on a user's usage history including information regarding a product purchased by the user.

4. The information processing apparatus according to claim 1, wherein the graph is a radar chart.

5. A method for introducing a product, the method comprising:
storing in a storage unit, by an information processing apparatus, item value information representing item values of respective evaluation items of each product, the item values being results of evaluation regarding the respective evaluation items;
creating, when information on a presented product is presented to a user of a terminal device connected to the information processing apparatus via a network, graph information for depicting a graph representing item values of respective evaluation items of the presented product and ranges of item values of respective evaluation items among products in a product group including the presented product, with reference to the item value information stored in the storage unit; and
transmitting the created graph information to the terminal device via the network.

6. A computer-readable recording medium storing a program that causes a computer to execute a procedure, the procedure comprising:
storing, in a storage unit, item value information representing item values of respective evaluation items of each product, the item values being results of evaluation regarding the respective evaluation items;
creating, when information on a presented product is presented to a user of a terminal device connected to the computer via a network, graph information for depicting a graph representing item values of respective evaluation items of the presented product and ranges of item values of respective evaluation items among products in a product group including the presented product, with reference to the item value information stored in the storage unit; and
transmitting the created graph information to the terminal device via the network.
